(19) United States
(12) Patent Application Publication
(10) Pub. No.: US 2025/0364626 A1
(43) Pub. Date: Nov. 27, 2025

(54) BATTERY STORAGE CASE

(71) Applicants: HYUNDAI MOTOR COMPANY, Seoul (KR); KIA CORPORATION, Seoul (KR)

(72) Inventors: Jong Gyu PARK, Hwaseong-si (KR); Kyung Mo KIM, Hwaseong-si (KR); Gun Woo KO, Hwaseong-si (KR); Chan Sol KIM, Hwaseong-si (KR)

(73) Assignees: HYUNDAI MOTOR COMPANY, Seoul (KR); KIA CORPORATION, Seoul (KR)

(21) Appl. No.: 18/939,126

(22) Filed: Nov. 6, 2024

(30) Foreign Application Priority Data
May 24, 2024 (KR) 10-2024-0068052

(51) Int. Cl. H01M 10/6556; H01M 10/613; H01M 10/6566; H01M 10/6568; H01M 50/233

(52) U.S. Cl. CPC H01M 10/6556; H01M 10/613; H01M 10/6566; H01M 10/6568; H01M 50/233

(57) ABSTRACT

A battery storage case includes a lower surface portion, in which the lower surface portion includes a plurality of main flow path defining members respectively including main cooling flow paths extending in a first direction, the plurality of main flow path defining members being disposed in a second direction intersecting the first direction, and a sub-flow path defining member provided at one side of the plurality of main flow path defining members based on the first direction and including a sub-cooling flow path extending in the second direction, and in which the main cooling flow path and the sub-cooling flow path of the sub-flow path defining member at least partially overlap each other in a third direction intersecting the first direction and the second direction.

### CROSS-REFERENCE TO RELATED APPLICATION

The present application claims priority to Korean Patent Application No. 10-2024-0068052 filed on May 24, 2024, the entire contents of which is incorporated herein for all purposes by this reference.

### BACKGROUND OF THE PRESENT DISCLOSURE

### Field of the Present Disclosure

The present disclosure relates to a battery storage case, and more particularly, to a case having a flow path through which a cooling fluid flows.

### Description of Related Art

For a battery pack having a structure provided with a plurality of batteries, it is important not only to maximize energy density per unit volume but also to ensure safety by preventing the occurrence of events such as fire or explosion.

Meanwhile, it is necessary to satisfy various conditions to ensure the safety of the battery pack. One of the conditions is a cooling structure capable of effectively discharging heat generated from the batteries in the battery pack. Therefore, the battery pack needs to include a cooling flow path through which a cooling fluid, such as a coolant or air, flows.

However, generally, the cooling flow path formed in the battery pack causes a problem in that a deviation between degrees to which the batteries are cooled greatly varies depending on the positions of the batteries disposed in the battery pack. This problem adversely affects heat dissipation performance essentially required for the battery pack, which degrades the safety of the battery pack.

Meanwhile, with an increasing demand for electric vehicles, requirements for physical rigidity of the battery pack have become strict. Generally, constituent components for defining the cooling flow path applied to the battery pack are typically manufactured by a pressing process, which causes a problem in that the battery pack includes a limitation in terms of physical rigidity.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a battery pack configured for improving physical rigidity of a battery pack while minimizing a deviation between degrees to which batteries disposed in the battery pack are cooled in accordance with positions of the batteries.

To achieve the above-mentioned object, one aspect of the present disclosure provides a battery storage case including an accommodation space formed therein, the battery storage case including: a lower surface portion defining a lower surface of the case, in which the lower surface portion includes: a plurality of main flow path defining members respectively including main cooling flow paths extending in a first direction, the plurality of main flow path defining members being disposed in a second direction intersecting the first direction; and a sub-flow path defining member provided at one side of the plurality of main flow path defining members based on the first direction and including a sub-cooling flow path extending in the second direction, and in which the main cooling flow path and the sub-cooling flow path of the sub-flow path defining member at least partially overlap each other in a third direction intersecting the first direction and the second direction.

Side surfaces of two adjacent main flow path defining members based on the second direction among the plurality of main flow path defining members may be tightly attached to each other, and communication holes may be formed in the side surfaces of the two adjacent main flow path defining members based on the second direction and allow the main cooling flow paths respectively formed in the two adjacent main flow path defining members to fluidically-communicate with each other.

The communication holes may be provided as a plurality of communication holes spaced apart from one another in the first direction.

The sub-flow path defining member may include: an inlet flow path defining member including an inlet cooling flow path, in the sub-cooling flow path, configured to fluidically-communicate with the main cooling flow path and allow a cooling fluid to be supplied to the main cooling flow path; and an outlet flow path defining member including an outlet cooling flow path, in the sub-cooling flow path, configured to fluidically-communicate with the main cooling flow path and allow the cooling fluid in the main cooling flow path to be introduced thereinto, and the inlet flow path defining member and the outlet flow path defining member may be provided to face each other in the first direction.

The inlet flow path defining member may be disposed between the main flow path defining member and the outlet flow path defining member in the first direction.

The inlet flow path defining member and the main flow path defining member may be tightly attached to each other, a first stepped region including a stepped shape may be formed in a region of the inlet flow path defining member tightly attached to the main flow path defining member, and a second stepped region including a shape corresponding to the first stepped region may be formed in a region of the main flow path defining member tightly attached to the first stepped region.

Two opposite end portions of the main flow path defining member based on the first direction may have perforated shapes.

The main cooling flow paths formed in some of the plurality of main flow path defining members may fluidically-communicate directly with the inlet cooling flow path, and the main cooling flow paths formed in some of the remaining main flow path defining members may fluidically-communicate indirectly with the inlet cooling flow path through the main cooling flow path (hereinafter, referred to as an ‘inlet communication cooling flow path’) that fluidically-communicates directly with the inlet cooling flow path.

The inlet communication cooling flow path may be formed inwardly of the main cooling flow path, which fluidically-communicates indirectly with the inlet cooling flow path through the inlet communication cooling flow path among the main cooling flow paths, based on the second direction.

The main cooling flow path (hereinafter, referred to as an ‘outlet communication cooling flow path’), which fluidically-communicates indirectly with the inlet cooling flow path through the inlet communication cooling flow path among the main cooling flow paths, may fluidically-communicate directly with the outlet cooling flow path.

The outlet communication cooling flow path may be formed outward of the inlet communication cooling flow path based on the first direction.

The main flow path defining members may include: a central main flow path defining member provided in a central region based on the second direction; and a first external main flow path defining member tightly attached to one side of the central main flow path defining member based on the second direction, the communication holes may include first communication holes respectively formed in the central main flow path defining member and the first external main flow path defining member in a region in which the central main flow path defining member and the first external main flow path defining member are tightly attached to each other, and the first communication hole may be formed to be biased and adjacent to a first side end portion of the main flow path defining member based on the first direction.

The main flow path defining members may further include a second external main flow path defining member tightly attached to one side of the first external main flow path defining member based on the second direction, the communication holes may further include second communication holes respectively formed in the first external main flow path defining member and the second external main flow path defining member in a region in which the first external main flow path defining member and the second external main flow path defining member are tightly attached to each other, and the second communication hole may be formed to be biased and adjacent to a second side end portion of the main flow path defining member based on the first direction.

The main flow path defining members may further include a third external main flow path defining member tightly attached to one side of the second external main flow path defining member based on the second direction, the communication holes may further include third communication holes respectively formed in the second external main flow path defining member and the third external main flow path defining member in a region in which the second external main flow path defining member and the third external main flow path defining member are tightly attached to each other, and the third communication hole may be formed to be biased and adjacent to the first side end portion of the main flow path defining member based on the first direction.

The central main flow path defining member may further include a central partition wall region extending in the first direction and configured to divide the main cooling flow path formed in the central main flow path defining member, and the second side end portion of the central main flow path defining member based on the first direction and the central partition wall region may be provided to be spaced apart from each other.

The first external main flow path defining member may further include a first external partition wall region extending in the first direction and configured to divide the main cooling flow path formed in the first external main flow path defining member, and the second side end portion of the first external main flow path defining member based on the first direction and the first external partition wall region may be provided to be spaced apart from each other.

The second external main flow path defining member may further include a second external partition wall region extending in the first direction and configured to divide the main cooling flow path formed in the second external main flow path defining member, and the first and second side end portions of the second external main flow path defining member based on the first direction and the second external partition wall region may be provided to be spaced apart from one another.

The third external main flow path defining member may further include a third external partition wall region extending in the first direction and configured to divide the main cooling flow path formed in the third external main flow path defining member, and the second side end portion of the third external main flow path defining member based on the first direction and the third external partition wall region may be provided to be spaced apart from each other.

A portion of the third external main flow path defining member, which is provided outward of the third external partition wall region based on the second direction, may further protrude toward one side based on the forward/rearward direction W than a portion of the third external main flow path defining member which is provided inwardly of the third external partition wall region based on the second direction.

The sub-flow path defining member may include: an inlet flow path defining member including an inlet cooling flow path, in the sub-cooling flow path, configured to fluidically-communicate with the main cooling flow path and allow a cooling fluid to be supplied to the main cooling fluid; and an outlet flow path defining member including an outlet cooling flow path, in the sub-cooling flow path, configured to fluidically-communicate with the main cooling flow path and allow the cooling fluid in the main cooling fluid to be introduced thereinto, the portion of the third external main flow path defining member, which is provided outward of the third external partition wall region based on the second direction, may be tightly attached to the outlet flow path defining member in the first direction, and a portion of the third external main flow path defining member, which is provided inwardly of the third external partition wall region based on the second direction, may be tightly attached to the inlet flow path defining member in the first direction.

One or more partition wall through-holes may be formed in the first external partition wall region, and the partition wall through-hole formed in the first external partition wall region may be formed to be biased and adjacent to the second side end portion of the first external main flow path defining member based on the first direction.

One or more partition wall through-holes may be formed in the second external partition wall region, and the partition wall through-hole formed in the second external partition wall region may be formed to be biased and adjacent to the second side end portion of the second external main flow path defining member based on the first direction.

According to an exemplary embodiment of the present disclosure, it is possible to provide the battery pack configured for improving the physical rigidity of a battery pack while minimizing the deviation between the degrees to which batteries disposed in the battery pack are cooled in accordance with the positions of the batteries.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a perspective view exemplarily illustrating a battery storage case according to an exemplary embodiment of the present disclosure.

FIG. 2 is an exploded perspective view exemplarily illustrating the battery storage case according to an exemplary embodiment of the present disclosure.

FIG. 3 is an enlarged view of a coupling structure between a main flow path defining member and a sub-flow path defining member of the battery storage case according to an exemplary embodiment of the present disclosure.

FIG. 4 is a view for explaining a flow direction of a cooling fluid in the vicinity of the sub-flow path defining member of the battery storage case according to an exemplary embodiment of the present disclosure.

FIG. 5 is a view exemplarily illustrating an internal structure of the battery storage case according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, a battery storage case according to an exemplary embodiment of the present disclosure will be described with reference to the drawings.

### Battery Storage Case

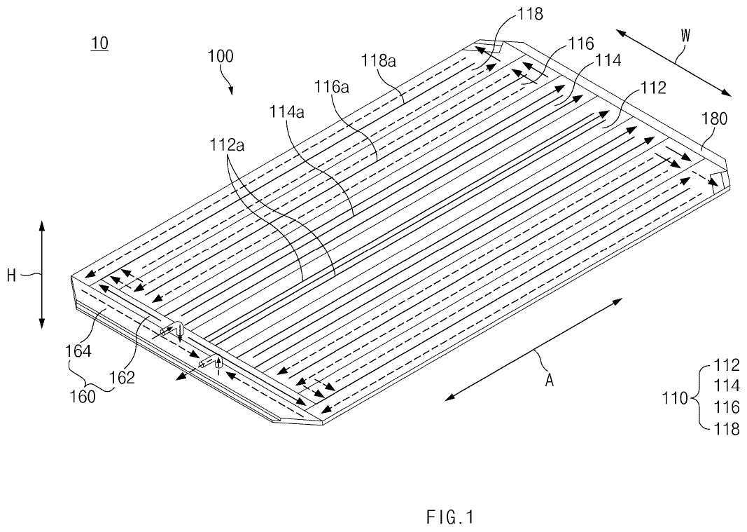

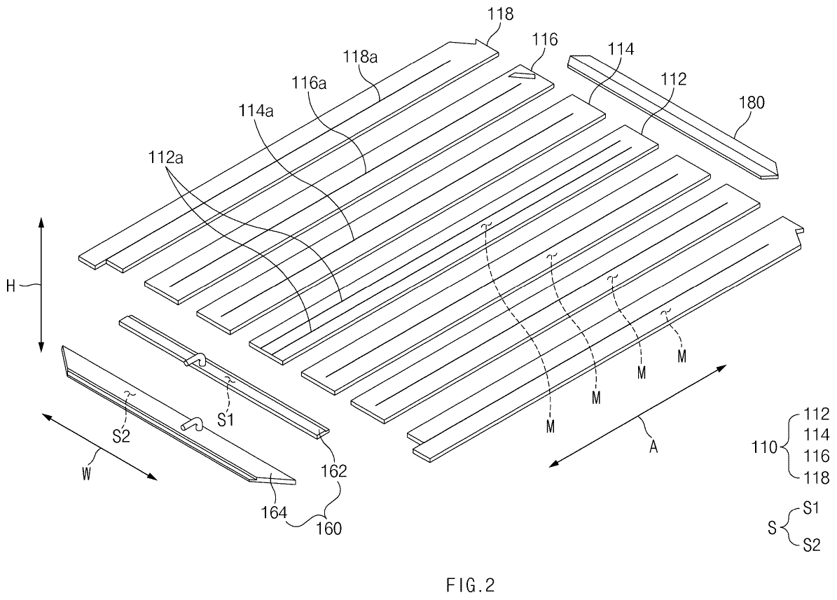

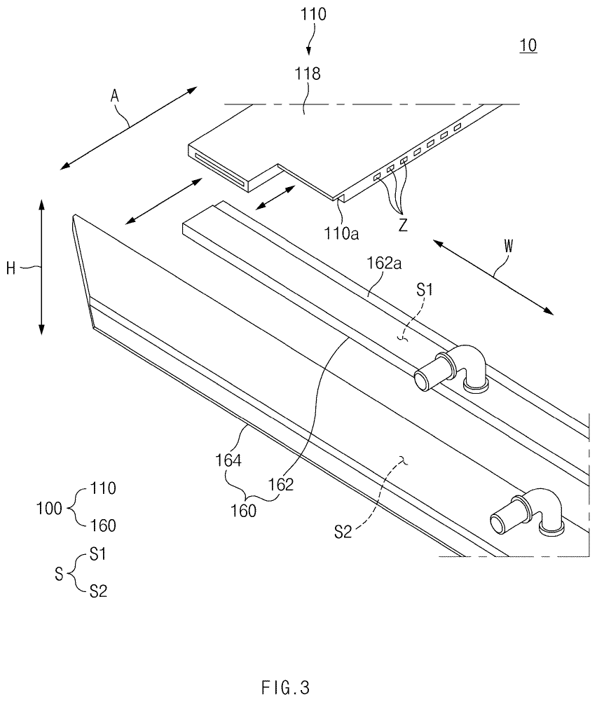

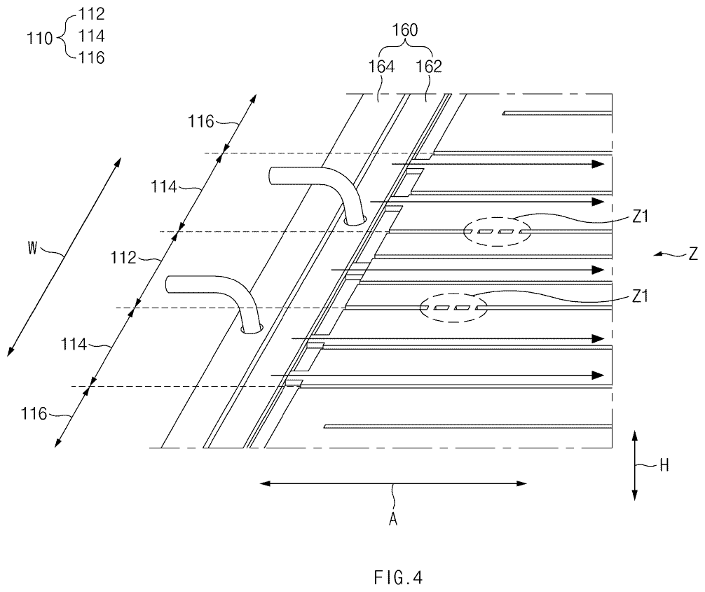

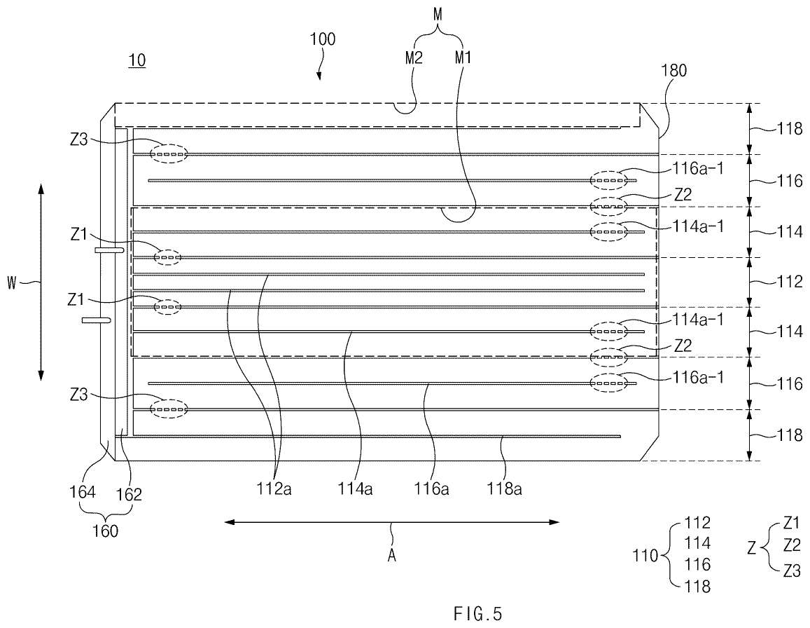

FIG. 1 is a perspective view exemplarily illustrating a battery storage case according to an exemplary embodiment of the present disclosure, and FIG. 2 is an exploded perspective view exemplarily illustrating the battery storage case according to an exemplary embodiment of the present disclosure. FIG. 3 is an enlarged view of a coupling structure between a main flow path defining member and a sub-flow path defining member of the battery storage case according to an exemplary embodiment of the present disclosure, and FIG. 4 is a view for explaining a flow direction of a cooling fluid in the vicinity of the sub-flow path defining member of the battery storage case according to an exemplary embodiment of the present disclosure. FIG. 5 is a view exemplarily illustrating an internal structure of the battery storage case according to an exemplary embodiment of the present disclosure.

The battery storage case according to an exemplary embodiment of the present disclosure may be configured to accommodate one or more batteries. For example, the battery may be a lithium-ion battery. However, the type of battery is not limited thereto. The battery may be a secondary battery.

The battery storage case according to an exemplary embodiment of the present disclosure may be configured to accommodate one or more batteries while defining an external surface of a battery pack. That is, the battery storage case according to an exemplary embodiment of the present disclosure may be a case of the battery pack. However, the battery storage case may also be applied to various types of structures (e.g., a battery module) configured for accommodating the batteries without being limited to the name ‘battery pack’.

With reference to the drawings, a battery storage case 10 according to an exemplary embodiment of the present disclosure may include an accommodation space formed therein. The accommodation space may be a space that accommodates a battery stack including a structure in which a plurality of batteries are stacked. Furthermore, the accommodation space is configured as a space for accommodating other components, such as busbars or various types of electrical components, mounted in the battery pack. Hereinafter, for convenience of description, the battery storage case is referred to as a ‘case’.

The case 10 may include a lower surface portion 100 configured to define a lower surface of the case, and a lateral surface portion defining a lateral surface region of the case. The lower surface portion 100 and the lateral surface portion may define the above-mentioned accommodation space. The configuration in which the lower surface portion and the lateral surface portion define the accommodation space may be understood as a configuration in which the lower surface portion and the lateral surface portion define a boundary of the accommodation space. Meanwhile, in the present specification, based on the drawings, a direction in which the lower surface portion 100 is directed toward the accommodation space is defined as an upward/downward direction H. However, the present configuration is provided only for convenience of description and does not mean that the lower surface portion 100 of the case 10 is necessarily disposed at a lower side of the case in actual use. For example, in actual use, the lower surface portion 100 of the case 10 may be disposed at one side or an upper side based on a horizontal direction thereof.

Meanwhile, according to an exemplary embodiment of the present disclosure, an internal space may be formed in the lower surface portion 100. A cooling flow path may be formed in the lower surface portion 100 and define a path through which a cooling fluid flows. That is, the cooling flow path may be understood as an empty space defined by the lower surface portion 100.

According to an exemplary embodiment of the present disclosure, the cooling flow path formed in the lower surface portion 100 may include a shape in which the cooling fluid flowing through the cooling flow path may uniformly cool an entire battery stack accommodated in the accommodation space.

To achieve the above-mentioned object, according to an exemplary embodiment of the present disclosure, the lower surface portion 100 of the case 10 may be manufactured by assembling a plurality of members manufactured separately.

The lower surface portion 100 may include a plurality of main flow path defining members 110 respectively including main cooling flow paths M extending in a forward/rearward direction A, which is one of the directions perpendicularly intersecting the upward/downward direction H, the plurality of main flow path defining members 110 being disposed in a leftward/rightward direction W perpendicularly intersecting the upward/downward direction H and the forward/rearward direction A, and a sub-flow path defining member 160 provided at one side of the plurality of main flow path defining members 110 based on the forward/rearward direction A and including a sub-cooling flow path extending in the leftward/rightward direction W. The cooling fluid, which flows through the main cooling flow path M formed in the main flow path defining member 110, may cool the battery accommodated or supported by the case 10. The sub-cooling flow path formed in the sub-flow path defining member 160 may define a flow path, through which the cooling fluid is supplied to the main cooling flow path M, and a flow path through which the cooling fluid is discharged from the main cooling flow path M.

In the instant case, according to an exemplary embodiment of the present disclosure, the main cooling flow path M and the sub-cooling flow path, which are respectively defined by the main flow path defining member 110 and the sub-flow path defining member 160, may overlap each other in the upward/downward direction H. The main cooling flow path M and the sub-cooling flow path may at least partially overlap each other in the upward/downward direction H perpendicularly intersecting the forward/rearward direction A and the leftward/rightward direction W. The main cooling flow path M and the sub-cooling flow path may be formed at the same height based on the upward/downward direction H.

According to an exemplary embodiment of the present disclosure, the main flow path defining member 110 and the sub-flow path defining member 160 may be manufactured by extrusion molding. The case 10 according to an exemplary embodiment of the present disclosure manufactured by extrusion molding is advantageous in improving the physical rigidity of the main flow path defining member 110 and the sub-flow path defining member 160 in comparison with the case manufactured by other methods such as a pressing process.

Meanwhile, when the main flow path defining member 110 and the sub-flow path defining member 160 are manufactured by extrusion molding as described above, the main cooling flow path M and the sub-cooling flow path may each include only a section extending in one direction because of the nature of the extrusion molding. Therefore, when the main flow path defining member 110 and the sub-flow path defining member 160 are manufactured by extrusion molding, a positional relationship between the main flow path defining member 110 and the sub-flow path defining member 160 needs to be optimized so that the main cooling flow path M and the sub-cooling flow path overlap each other in the upward/downward direction H without interfering with each other. Hereinafter, the relative positional relationship and coupling relationship between the main flow path defining member 110 and the sub-flow path defining member 160 will be described in detail.

With reference to FIG. 1 and FIG. 2, side surfaces of two main flow path defining members 110 based on the leftward/rightward direction W, the two main flow path defining members 100 being adjacent to each other among the plurality of main flow path defining members 110, may be tightly attached to each other. For example, the two adjacent main flow path defining members 110 may be joined to each other by welding.

In the instant case, the main cooling flow paths M respectively formed in the two adjacent main flow path defining members 110 may fluidically-communicate directly with each other. According to an exemplary embodiment of the present disclosure, communication holes Z may be formed in the side surfaces of the two adjacent main flow path defining members 110 based on the leftward/rightward direction W and allow the main cooling flow paths M respectively formed in the two adjacent main flow path defining members 110 to fluidically-communicate with each other. In the instant case, the cooling fluid, which flows through one of the two main cooling flow paths respectively formed in the two adjacent main flow path defining members 110, may be supplied to another main cooling flow path through the communication hole Z.

Meanwhile, the communication hole Z may include a relatively smaller size than a cross-sectional area of the main cooling flow path based on the leftward/rightward direction W. Furthermore, the communication holes Z, which are formed in each of the main flow path defining members 110, may be provided as a plurality of communication holes Z spaced apart from one another in the forward/rearward direction A.

Meanwhile, the sub-flow path defining member 160 may provide the path, through which the cooling fluid is supplied to the main cooling flow path, and the path through which the cooling fluid is discharged from the main cooling flow path. The sub-flow path defining member 160 may include an inlet flow path defining member 162 including an inlet cooling flow path S1, in the sub-cooling flow path, configured to fluidically-communicate with the main cooling flow path M and allow the cooling fluid to be supplied to the main cooling flow path, and an outlet flow path defining member 164 including an outlet cooling flow path S2, in the sub-cooling flow path, configured to fluidically-communicate with the main cooling flow path M and allow the cooling fluid in the main cooling flow path M to be introduced thereinto. The inlet flow path defining member 162 and the outlet flow path defining member 164 may be separately manufactured and tightly attached to each other. For example, the inlet flow path defining member 162 and the outlet flow path defining member 164 may be joined to each other by welding.

The inlet flow path defining member 162 and the outlet flow path defining member 164 may be provided to face each other in the forward/rearward direction A. The inlet flow path defining member 162 may be disposed between the plurality of main flow path defining members 110 and the outlet flow path defining member 164 in the forward/rearward direction A.

Meanwhile, with continued reference to FIG. 1, FIG. 2, and FIG. 3, the inlet flow path defining member 162 and the main flow path defining member 110 may be tightly attached to each other. In the instant case, a first stepped region 162a including a stepped shape may be formed in a region of the inlet flow path defining member 162 tightly attached to the main flow path defining member 110, and a second stepped region 110a, which includes a shape corresponding to the first stepped region 162a, may be formed in a region of the main flow path defining member 110 tightly attached to the first stepped region 162a. For example, the regions in which the first stepped region 162a and the second stepped region 110a are tightly attached to each other may be joined to each other by welding. Meanwhile, like the inlet flow path defining member 162 and the main flow path defining member 110, stepped regions, which have shapes corresponding to each other, may also be formed on the outlet flow path defining member 164 and the main flow path defining member 110, and the outlet flow path defining member 164 and the main flow path defining member 110 may be tightly attached to each other in the stepped regions.

Meanwhile, as described above, according to an exemplary embodiment of the present disclosure, the main flow path defining member 110 may be manufactured by extrusion molding. In the instant case, two opposite end portions of the main flow path defining member 110 based on the forward/rearward direction A may each include a perforated shape. In the instant case, the configuration in which the two opposite end portions of the main flow path defining member 110 based on the forward/rearward direction A have perforated shapes may be described based on a state in which the main flow path defining member 110 is spaced apart from the other components of the case 10 according to an exemplary embodiment of the present disclosure. That is, when the main flow path defining member 110 is viewed individually, the main cooling flow path M in the main flow path defining member 110 may fluidically-communicate with the outside because the two opposite end portions of the main flow path defining member 110 based on the forward/rearward direction A are perforated. However, the two opposite end portions of the main flow path defining member 110 based on the forward/rearward direction A may be tightly attached to other components, e.g., one side surface of the inlet flow path defining member 162 during the process of manufacturing the case 10 according to an exemplary embodiment of the present disclosure so that the main cooling flow path M may be sealed from the outside thereof based on the state in which the case 10 is completely manufactured.

Meanwhile, according to an exemplary embodiment of the present disclosure, a portion of the main cooling flow path M defined by the main flow path defining member 110 may fluidically-communicate directly with the inlet flow path defining member 162 of the sub-flow path defining member 160, and another portion of the main cooling flow path M may fluidically-communicate directly with the outlet flow path defining member 164 of the sub-flow path defining member 160. Meanwhile, in the present specification, the configuration in which the two flow paths fluidically-communicate directly with each other may mean that the two flow paths are not connected by a mediation flow path, but one end portion of one flow path and one end portion of the other flow path are in direct contact with each other.

With reference to FIG. 4 and FIG. 5, the main cooling flow paths formed in some of the plurality of main flow path defining members M may fluidically-communicate directly with the inlet cooling flow path 162, and the main cooling flow paths formed in some of the remaining main flow path defining members M may fluidically-communicate indirectly with the inlet cooling flow path S1 through the main cooling flow path M (hereinafter, referred to as an ‘inlet communication cooling flow path M1’) that fluidically-communicates directly with the inlet cooling flow path S1. Therefore, the cooling fluid, which is supplied from the outside thereof through the inlet cooling flow path S1, may be supplied to the inlet communication cooling flow path M1.

Meanwhile, with continued reference to FIG. 4 and FIG. 5, the main cooling flow path (hereinafter, referred to as an ‘outlet communication cooling flow path M2’), which fluidically-communicates indirectly with the inlet cooling flow path S1 through the inlet communication cooling flow path M1 among the main cooling flow paths M, may fluidically-communicate directly with the outlet cooling flow path S2. Therefore, the cooling fluid, which flows through the inlet communication cooling flow path M1, may be introduced into the outlet cooling flow path S2 through the outlet communication cooling flow path M2 and then discharged to the outside thereof.

Furthermore, according to an exemplary embodiment of the present disclosure, as illustrated in FIG. 5, the inlet communication cooling flow path M1 may be disposed inwardly of the outlet communication cooling flow path M2 based on the leftward/rightward direction W. All the inlet communication cooling flow paths M1 may be formed inwardly of all the outlet communication cooling flow paths M2 based on the leftward/rightward direction W.

When the batteries are disposed in the case 10 according to an exemplary embodiment of the present disclosure, heat may be relatively smoothly dissipated from the battery disposed to face an external region of the case 10 based on the leftward/rightward direction W among the batteries. In contrast, heat cannot be relatively smoothly dissipated from the battery, which is positioned to face an internal region (i.e., a central region) of the case 10 based on the leftward/rightward direction W, because of other batteries adjacent to one another in the leftward/rightward direction W.

Therefore, according to the above-mentioned configuration of the present disclosure, the inlet communication cooling flow path M1 may be formed in a central region of the case 10 based on the leftward/rightward direction W so that the relatively low-temperature cooling fluid, which is supplied from the outside thereof through the inlet cooling flow path S1, may cool, first, the battery disposed to face the central region of the case 10 based on the leftward/rightward direction W.

Meanwhile, according to an exemplary embodiment of the present disclosure, the plurality of main flow path defining members 110 may be denoted by different names depending on the positions at which the plurality of main flow path defining members 110 is disposed. The main flow path defining members 110 may include a central main flow path defining member 112 provided in the central region based on the leftward/rightward direction W, and a first external main flow path defining member 114 tightly attached to one side of the central main flow path defining member 112 based on the leftward/rightward direction W. The first external main flow path defining members 114 may be tightly attached to the two opposite sides of the central main flow path defining member 112 based on the leftward/rightward direction W.

In the instant case, the communication holes Z may include first communication holes Z1 respectively formed in the central main flow path defining member 112 and the first external main flow path defining member 114 in the region in which the central main flow path defining member 112 and the first external main flow path defining member 114 are tightly attached to each other. In the instant case, the first communication hole Z1 may be formed to be biased toward one side based on the forward/rearward direction A. For example, with reference to FIG. 5, the first communication hole Z1 may be formed to be biased and adjacent to a first side end portion of the main flow path defining member 110 based on the forward/rearward direction A. In the instant case, the first side end portion based on the forward/rearward direction A may mean an end portion of the two opposite end portions of the main flow path defining member 110 based on the forward/rearward direction A, i.e., the end portion to which the inlet flow path defining member 162 and the outlet flow path defining member 164 are coupled (i.e., a left end portion based on FIG. 5).

With continued reference to FIG. 5, the main flow path defining members 110 may further include a second external main flow path defining member 116 tightly attached to one side of the first external main flow path defining member 114 based on the leftward/rightward direction W. The second external main flow path defining members 116 may be provided to be respectively tightly attached to external sides of the two first external main flow path defining members 114 based on the leftward/rightward direction W.

In the instant case, the communication holes Z may further include second communication holes Z2 respectively formed in the first external main flow path defining member 114 and the second external main flow path defining member 116 in the region in which the first external main flow path defining member 114 and the second external main flow path defining member 116 are tightly attached to each other. In the instant case, similar to the first communication hole Z1, the second communication hole Z2 may also be formed to be biased toward one side based on the forward/rearward direction A. For example, with reference to FIG. 5, the second communication hole Z2 may be formed to be biased and adjacent to a second side end portion of the main flow path defining member 110 based on the forward/rearward direction A. In the instant case, the second side end portion based on the forward/rearward direction A may mean an end portion of the two opposite end portions of the main flow path defining member 110, i.e., an opposite end portion which is not the end portion to which the inlet flow path defining member 162 and the outlet flow path defining member 164 are coupled.

With continued reference to FIG. 5, the main flow path defining members 110 may further include a third external main flow path defining member 118 tightly attached to one side of the second external main flow path defining member 116 based on the leftward/rightward direction W. The third external main flow path defining members 118 may be provided to be respectively tightly attached to external sides of the two second external main flow path defining members 116 based on the leftward/rightward direction W.

In the instant case, the communication holes Z may further include third communication holes Z3 respectively formed in the second external main flow path defining member 116 and the third external main flow path defining member 118 in the region in which the second external main flow path defining member 116 and the third external main flow path defining member 118 are tightly attached to each other. In the instant case, similar to the first communication hole Z1 and the second communication hole Z2, the third communication hole Z3 may also be formed to be biased toward one side based on the forward/rearward direction A. For example, with reference to FIG. 5, the third communication hole Z3 may be formed to be biased and adjacent to the first side end portion of the main flow path defining member 110 based on the forward/rearward direction A.

Meanwhile, according to an exemplary embodiment of the present disclosure, the cooling flow paths formed in the plurality of main flow path defining members 110 may be divided into a plurality of regions by partition wall structures.

With reference to FIG. 5, the central main flow path defining member 112 may further include central partition wall regions 112a extending in the forward/rearward direction A and configured to divide the main cooling flow path M formed in the central main flow path defining member 112. That is, the main cooling flow path M in the central main flow path defining member 112 may be divided by the central partition wall regions 112a into a plurality of cooling flow paths spaced apart from one another in the leftward/rightward direction W. For example, FIG. 5 illustrates that two central partition wall regions 112a are provided to be spaced apart from each other in the leftward/rightward direction W. In the instant case, the main cooling flow path M in the central main flow path defining member 112 may be divided into three regions.

In the instant case, according to an exemplary embodiment of the present disclosure, the second side end portion (the right end portion based on FIG. 5) of the central main flow path defining member 112 based on the forward/rearward direction A and the central partition wall region 112a may be provided to be spaced apart from each other, and the first side end portion (the left end portion based on FIG. 5) of the central main flow path defining member 112 based on the forward/rearward direction A and the central partition wall region 112a are provided to be connected to each other. Therefore, the main cooling flow paths M in the central main flow path defining member 112 separated by the central partition wall region 112a may fluidically-communicate with one another.

Furthermore, the first external main flow path defining member 114 may further include a first external partition wall region 114a extending in the forward/rearward direction A and configured to divide the main cooling flow path M formed in the first external main flow path defining member 114. For example, FIG. 5 illustrates that one first external partition wall region 114a is provided. In the instant case, the main cooling flow path M in the first external main flow path defining member 114 may be divided into two regions.

In the instant case, according to an exemplary embodiment of the present disclosure, the second side end portion of the first external main flow path defining member 114 based on the forward/rearward direction A and the first external partition wall region 114a may be provided to be spaced apart from each other, and the first side end portion of the first external main flow path defining member 114 based on the forward/rearward direction A and the first external partition wall region 114a may be provided to be connected to each other. Therefore, the main cooling flow paths M in the first external main flow path defining member 114 separated by the first external partition wall region 114a may fluidically-communicate with each other.

Meanwhile, the second external main flow path defining member 116 may further include a second external partition wall region 116a extending in the forward/rearward direction A and configured to divide the main cooling flow path M formed in the second external main flow path defining member 116. For example, FIG. 5 illustrates that one second external partition wall region 116a is provided. In the instant case, the main cooling flow path M in the second external main flow path defining member 116 may be divided into two regions.

In the instant case, according to an exemplary embodiment of the present disclosure, the first and second side end portions of the second external main flow path defining member 116 based on the forward/rearward direction A and the second external partition wall region 116a may be provided to be spaced apart from each other. Therefore, the main cooling flow paths M in the second external main flow path defining member 116 separated by the second external partition wall region 116a may fluidically-communicate with each other at the two opposite end portions based on the forward/rearward direction A.

With continued reference to FIG. 5, the third external main flow path defining member 118 may further include a third external partition wall region 118a extending in the forward/rearward direction A and configured to divide the main cooling flow path M formed in the third external main flow path defining member 118. For example, FIG. 5 illustrates that one third external partition wall region 118a is provided. In the instant case, the main cooling flow path M in the third external main flow path defining member 118 may be divided into two regions.

In the instant case, according to an exemplary embodiment of the present disclosure, the second side end portion of the third external main flow path defining member 118 based on the forward/rearward direction A and the third external partition wall region 118a may be provided to be spaced apart from each other, and the first side end portion of the third external main flow path defining member 118 based on the forward/rearward direction A and the third external partition wall region 118a may be provided to be connected to each other. Therefore, the main cooling flow paths M in the third external main flow path defining member 118 separated by the third external partition wall region 118a may fluidically-communicate with each other.

Meanwhile, the outlet communication cooling flow path M2 may be formed in an outermost region of the case 10 based on the leftward/rightward direction W among the plurality of main cooling flow paths M, and the outlet cooling flow path S2 formed in the outlet flow path defining member 164 may fluidically-communicate with the main cooling flow path M formed at the outermost side of the case 10 based on the leftward/rightward direction W. In the instant case, with reference to FIGS. 2 and 5, a portion of the third external main flow path defining member 118, which is provided outward of the third external partition wall region 118a based on the leftward/rightward direction W, may further protrude toward one side based on the forward/rearward direction W than a portion of the third external main flow path defining member 118, which is provided inwardly of the third external partition wall region 118a based on the leftward/rightward direction W. The portion of the third external main flow path defining member 118, which is provided outward of the third external partition wall region 118a based on the leftward/rightward direction W, may further protrude toward the outlet flow path defining member 164 than the portion of the third external main flow path defining member 118, which is provided inwardly of the third external partition wall region 118a based on the leftward/rightward direction W, and the protruding portion may be connected to the outlet flow path defining member 164.

The portion of the third external main flow path defining member 118, which is provided outward of the third external partition wall region 118a based on the leftward/rightward direction W, may be tightly attached to the outlet flow path defining member 164 in the forward/rearward direction A, and a portion of the third external main flow path defining member 118, which is provided inwardly of the third external partition wall region 118a based on the leftward/rightward direction W, may be tightly attached to the inlet flow path defining member 162 in the forward/rearward direction A.

Meanwhile, according to an exemplary embodiment of the present disclosure, hole structures similar to the communication holes Z may be formed in the partition wall regions 112a, 114a, 116a, and 118a. With reference to FIG. 5, one or more partition wall through-holes 114a-1 may be formed in the first external partition wall region 114a. In the instant case, the partition wall through-hole 114a-1 formed in the first external partition wall region 114a may be formed to be biased and adjacent to the second side end portion (the right end portion based on FIG. 5) of the first external main flow path defining member 114 based on the forward/rearward direction A. For example, FIG. 5 illustrates that the plurality of partition wall through-holes 114a-1 is formed to face the second communication holes Z2.

Furthermore, one or more partition wall through-holes 116a-1 may also be formed in the second external partition wall region 116a. In the instant case, the partition wall through-hole 116a-1 formed in the second external partition wall region 116a may be formed to be biased and adjacent to the second side end portion (the right end portion based on FIG. 5) of the second external main flow path defining member 116. For example, FIG. 5 illustrates that the plurality of partition wall through-holes 116a-1 is formed to face the second communication holes Z2.

Meanwhile, with reference to FIG. 1 and FIG. 2, the case 10 according to an exemplary embodiment of the present disclosure may further include an assembling member 180 provided at one side of the plurality of main flow path defining members 110 based on the forward/rearward direction A and provided to face the sub-flow path defining member 160 with the main flow path defining members 110 interposed therebetween.

As described above, when the main flow path defining member 110 is manufactured by extrusion molding, the two opposite end portions of the main flow path defining member 110 based on the forward/rearward direction A may include the perforated shapes. The assembling member 180 may be configured to close one perforated end portion of the main flow path defining member 110 from the outside thereof, preventing the cooling fluid flowing through the main cooling flow path M from leaking to the outside thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A battery storage case including an accommodation space formed therein, the battery storage case comprising:
a lower surface portion defining a lower surface of the case,
wherein the lower surface portion includes:
a plurality of main flow path defining members respectively including main cooling flow paths extending in a first direction, the plurality of main flow path defining members being disposed in a second direction intersecting the first direction; and
a sub-flow path defining member provided at one side of the plurality of main flow path defining members based on the first direction and including a sub-cooling flow path extending in the second direction, and
wherein the main cooling flow path and the sub-cooling flow path of the sub-flow path defining member at least partially overlap each other in a third direction intersecting the first direction and the second direction.

2. The battery storage case of claim 1,
wherein side surfaces of two adjacent main flow path defining members based on the second direction among the plurality of main flow path defining members are attached to each other, and
wherein communication holes are formed in the side surfaces of the two adjacent main flow path defining members based on the second direction and allow the main cooling flow paths respectively formed in the two adjacent main flow path defining members to fluidically-communicate with each other.

3. The battery storage case of claim 1,
wherein the sub-flow path defining member includes:
an inlet flow path defining member including an inlet cooling flow path, in the sub-cooling flow path, fluidically-communicating with the main cooling flow path and allowing a cooling fluid to be supplied to the main cooling flow path; and
an outlet flow path defining member including an outlet cooling flow path, in the sub-cooling flow path, fluidically-communicating with the main cooling flow path and allowing the cooling fluid in the main cooling flow path to be introduced thereinto, and
wherein the inlet flow path defining member and the outlet flow path defining member are provided to face each other in the first direction.

4. The battery storage case of claim 3, wherein the inlet flow path defining member is disposed between the main flow path defining member and the outlet flow path defining member in the first direction.

5. The battery storage case of claim 4,
wherein the inlet flow path defining member and the main flow path defining member are attached to each other,
wherein a first stepped region including a stepped shape is formed in a region of the inlet flow path defining member attached to the main flow path defining member, and
wherein a second stepped region, which includes a shape corresponding to the first stepped region, is formed in a region of the main flow path defining member attached to the first stepped region.

6. The battery storage case of claim 3,
wherein the main cooling flow paths formed in some of the plurality of main flow path defining members fluidically-communicate directly with the inlet cooling flow path, and
wherein the main cooling flow paths formed in some of the remaining main flow path defining members fluidically-communicate indirectly with the inlet cooling flow path through the main cooling flow path to form an inlet communication cooling flow path that fluidically-communicates directly with the inlet cooling flow path.

7. The battery storage case of claim 6, wherein the inlet communication cooling flow path is formed inwardly of the main cooling flow path, which fluidically-communicates indirectly with the inlet cooling flow path through the inlet communication cooling flow path among the main cooling flow paths, based on the second direction.

8. The battery storage case of claim 7, wherein the main cooling flow path, which fluidically-communicates indirectly with the inlet cooling flow path through the inlet communication cooling flow path among the main cooling flow paths to form an outlet communication cooling flow path, fluidically-communicates directly with the outlet cooling flow path.

9. The battery storage case of claim 8, wherein the outlet communication cooling flow path is formed outward of the inlet communication cooling flow path based on the first direction.

10. The battery storage case of claim 2, wherein the main flow path defining members include:
a central main flow path defining member provided in a central region based on the second direction; and
a first external main flow path defining member attached to one side of the central main flow path defining member based on the second direction,
wherein the communication holes include first communication holes respectively formed in the central main flow path defining member and the first external main flow path defining member in a region in which the central main flow path defining member and the first external main flow path defining member are attached to each other, and
wherein the first communication hole is formed to be biased and adjacent to a first side end portion of the main flow path defining member based on the first direction.

11. The battery storage case of claim 10,
wherein the main flow path defining members further include a second external main flow path defining member attached to one side of the first external main flow path defining member based on the second direction,
wherein the communication holes further include second communication holes respectively formed in the first external main flow path defining member and the second external main flow path defining member in a region in which the first external main flow path defining member and the second external main flow path defining member are attached to each other, and
wherein the second communication hole is formed to be biased and adjacent to a second side end portion of the main flow path defining member based on the first direction.

12. The battery storage case of claim 11,
wherein the main flow path defining members further include a third external main flow path defining member attached to one side of the second external main flow path defining member based on the second direction,
wherein the communication holes further include third communication holes respectively formed in the second external main flow path defining member and the third external main flow path defining member in a region in which the second external main flow path defining member and the third external main flow path defining member are attached to each other, and
wherein the third communication hole is formed to be biased and adjacent to the first side end portion of the main flow path defining member based on the first direction.

13. The battery storage case of claim 10,
wherein the central main flow path defining member further includes a central partition wall region extending in the first direction and configured to divide the main cooling flow path formed in the central main flow path defining member, and
wherein a second side end portion of the central main flow path defining member based on the first direction and the central partition wall region are provided to be spaced apart from each other.

14. The battery storage case of claim 10,
wherein the first external main flow path defining member further includes a first external partition wall region extending in the first direction and dividing the main cooling flow path formed in the first external main flow path defining member, and
wherein a second side end portion of the first external main flow path defining member based on the first direction and the first external partition wall region are provided to be spaced apart from each other.

15. The battery storage case of claim 11,
wherein the second external main flow path defining member further includes a second external partition wall region extending in the first direction and dividing the main cooling flow path formed in the second external main flow path defining member, and
wherein first and second side end portions of the second external main flow path defining member based on the first direction and the second external partition wall region are provided to be spaced apart from one another.

16. The battery storage case of claim 12,
wherein the third external main flow path defining member further includes a third external partition wall region extending in the first direction and dividing the main cooling flow path formed in the third external main flow path defining member, and
wherein the second side end portion of the third external main flow path defining member based on the first direction and the third external partition wall region are provided to be spaced apart from each other.

17. The battery storage case of claim 12, wherein a portion of the third external main flow path defining member, which is provided outward of the third external partition wall region based on the second direction, further protrudes toward one side based on the first direction than a portion of the third external main flow path defining member, which is provided inwardly of the third external partition wall region based on the second direction.

18. The battery storage case of claim 17, wherein the sub-flow path defining member includes:
an inlet flow path defining member including an inlet cooling flow path, in the sub-cooling flow path, fluidically-communicating with the main cooling flow path and allowing a cooling fluid to be supplied to a main cooling fluid; and
an outlet flow path defining member including an outlet cooling flow path, in the sub-cooling flow path, fluidically-communicating with the main cooling flow path and allowing the cooling fluid in the main cooling fluid to be introduced thereinto,
wherein the portion of the third external main flow path defining member, which is provided outward of the third external partition wall region based on the second direction, is attached to the outlet flow path defining member in the first direction, and
wherein a portion of the third external main flow path defining member, which is provided inwardly of the third external partition wall region based on the second direction, is attached to the inlet flow path defining member in the first direction.

19. The battery storage case of claim 14,
wherein one or more partition wall through-holes are formed in the first external partition wall region, and
wherein the one or more partition wall through-holes formed in the first external partition wall region is formed to be biased and adjacent to a second side end portion of the first external main flow path defining member based on the first direction.

20. The battery storage case of claim 15,
wherein one or more partition wall through-holes are formed in the second external partition wall region, and
wherein the one or more partition wall through-holes formed in the second external partition wall region are formed to be biased and adjacent to the second side end portion of the second external main flow path defining member based on the first direction.
